(19) United States
(12) Patent Application Publication
(10) Pub. No.: US 2016/0056898 A1
(43) Pub. Date: Feb. 25, 2016

(54) TRANSMISSION APPARATUS AND TRANSMISSION SYSTEM

(71) Applicant: FUJITSU LIMITED, Kawasaki-shi (JP)

(72) Inventor: Satoru Saitoh, Kawasaki (JP)

(21) Appl. No.: 14/751,296

(22) Filed: Jun. 26, 2015

(30) Foreign Application Priority Data
Aug. 25, 2014 (JP) 2014-170589

(51) Int. Cl. H04B 10/54; H04B 10/564; H04J 14/02

(52) U.S. Cl. CPC H04B 10/54; H04J 14/0221; H04B 10/564

(57) ABSTRACT

A transmission apparatus includes: a backboard configured to be interposed between a detachable first unit and a detachable second unit, wherein the backboard includes: an electrical connector coupled to the first unit; an optical modulation unit configured to modulate light from a light source based on a first electrical signal from the first unit via the electrical connector and output a first optical signal; and a first optical transmission path configured to transmit the first optical signal to the second unit.

### CROSS-REFERENCE TO RELATED APPLICATION

This application is based upon and claims the benefit of priority from the prior Japanese Patent Application No. 2014-170589 filed on Aug. 25, 2014, the entire contents of which are incorporated herein by reference.

### FIELD

The embodiments discussed herein are related to a transmission apparatus and a transmission system.

### BACKGROUND

In a transmission apparatus used in, for example, a backbone network, transmission of data is performed through a backboard (BWB, back wiring board) between a plurality of interface units coupled to the backboard.

Related technologies are disclosed in, for example, Japanese Laid-Open Patent Publication No. 2004-336811 and Japanese Laid-Open Patent Publication No. 2009-177337.

### SUMMARY

According to one aspect of the embodiments, A transmission apparatus includes: a backboard configured to be interposed between a detachable first unit and a detachable second unit, wherein the backboard includes: an electrical connector coupled to the first unit; an optical modulation unit configured to modulate light from a light source based on a first electrical signal from the first unit via the electrical connector and output a first optical signal; and a first optical transmission path configured to transmit the first optical signal to the second unit.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating an exemplary configuration of a transmission apparatus;

FIG. 2 is a view illustrating an exemplary configuration of a transmission apparatus;

FIG. 3 is a view illustrating an exemplary backboard;

FIG. 4 is a view illustrating an exemplary operational characteristic of a modulator;

FIG. 5 is a view illustrating an exemplary transmission apparatus;

FIG. 6 is a view illustrating an exemplary backboard;

FIG. 7 is a view illustrating an exemplary AWG; and

FIG. 8 is a view illustrating an exemplary operational characteristic.

### DESCRIPTION OF EMBODIMENTS

In transmission and reception of data between interface units, the speed of a signal handled by interface units has been increased. Thus, an optical connection may be employed in a connection between the interface units through a backboard.

For example, when the optical signal is used in transmission and reception of the signal by an optical connection between the interface unit and the backboard, the speed of the signal between the interface units increases. However, the maintainability thereof or connection reliability therebetween may be degraded. For example, since an optical module in which a light emitting element is provided is employed in the interface unit, when a broken light emitting element of an optical module is replaced, the interface unit itself is replaced. For example, when the interface unit that has been preserved for a long time is mounted in the backboard, the optical signal is blocked by dusts adhered to an optical connector used for coupling the interface unit to the backboard so that the connection reliability therebetween may be degraded.

In an exemplary embodiment, same reference numerals will be given to a configuration having substantially the same function, and duplicate descriptions thereof will be omitted or reduced.

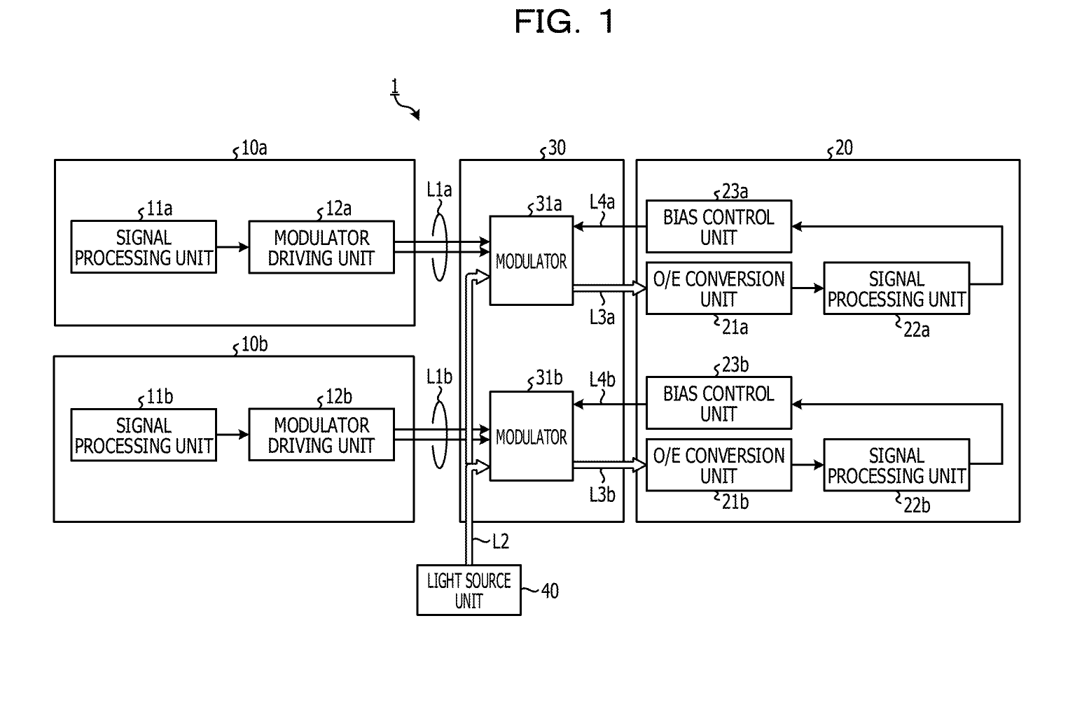

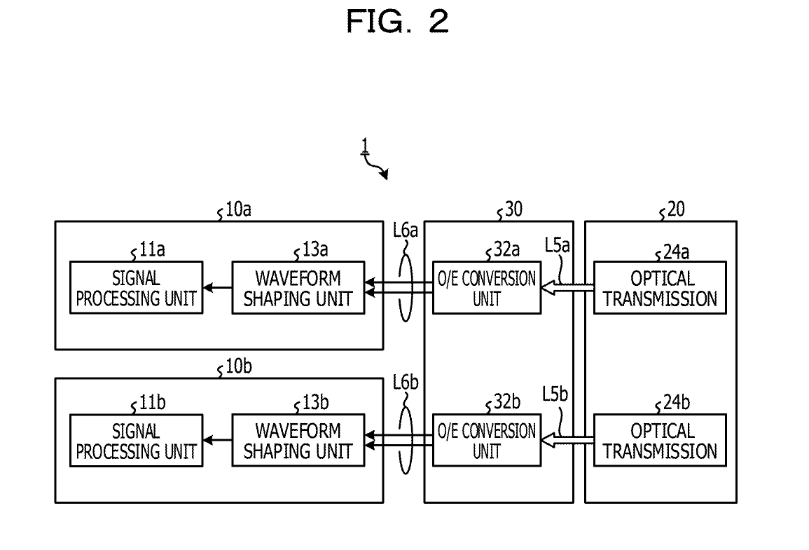

FIGS. 1 and 2 are views illustrating an exemplary configuration of a transmission apparatus. In FIG. 1, the transmission of the signal is performed from the interface units 10a and 10b to the switch unit 20 via the backboard 30. In FIG. 2, to the contrary, the transmission of the signal is performed from the switch unit 20 to the interface units 10a and 10b via the backboard 30.

As illustrated in FIG. 1, the interface unit 10a includes a signal processing unit 11a and a modulator driving unit 12a. Likewise, the interface unit 10b includes a signal processing unit 11b and a modulator driving unit 12b. The switch unit 20 includes O/E conversion units 21a and 21b, signal processing units 22a and 22b, and bias control units 23a and 23b, which correspond to the interface units 10a and 10b, respectively. The backboard 30 includes the modulators 31a and 31b which corresponds to the interface units 10a and 10b, respectively.

In the interface unit 10a, the signal input from outside via, for example, a connector is processed in the signal processing unit 11a so as to be output to the modulator driving unit 12a. The modulator driving unit 12a amplifies a signal from the signal processing unit 11a to output the amplified signal to the backboard 30 via an electrical transmission path L1a. Likewise, in the interface unit 10b, the signal input from the outside via, for example, a connector is processed in the signal processing unit 11b so as to be output to the modulator driving unit 12b. The modulator driving unit 12b amplifies a signal from the signal processing unit 11b to output the amplified signal to the backboard 30 via an electrical transmission path L1b.

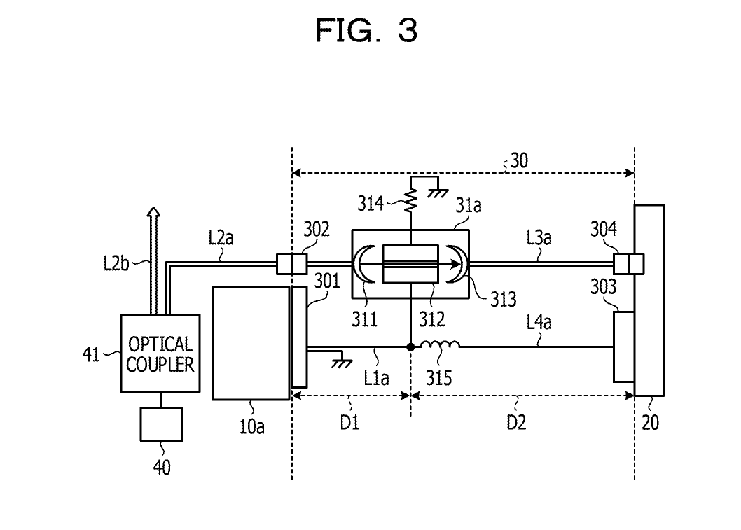

The interface units 10a and 10b are electrically coupled to the backboard 30 via the electrical transmission paths L1a and L1b each having a detachable electrical connector, respectively. The electrical connector may be, for example, an electrical connector 301 illustrated in FIG. 3. The interface units 10a and 10b are detachable to the backboard 30. An electrical signal from the modulator driving units 12a and 12b is transmitted to the modulators 31a and 31b via the electrical transmission paths L1a and L1b, respectively. A light signal from the light source unit 40 is input to the modulators 31a and 31b via the light transmission path L2. The light source unit 40 may be, for example, a laser light source which emits light having a certain wavelength. The light source unit 40 may be provided outside of the backboard 30, or may be provided on the backboard 30.

The modulators 31a and 31b modulate the light input via the light transmission path L2 based on the electrical signal input from the modulator driving units 12a and 12b via the transmission paths L1a and L1b. For example, the modulators 31a and 31b may be, for example, an EA (Electro Absorption) modulator when the light input via the light transmission path L2 has a single wavelength. An optical signal obtained by the modulation is transmitted to the O/E conversion units 21a and 21b of the switch unit 20 from optical transmission paths L3a and L3b coupled to an output side of the modulators 31a and 31b, respectively. The bias control units 23a and 23b of the switch unit 20 are coupled to the modulators 31a and 31b via the electrical transmission paths L4a and L4b, respectively. In the modulators 31a and 31b, a bias voltage serving as a reference of a modulation operation thereof is controlled by the bias control units 23a and 23b coupled thereto via the electrical transmission paths L4a and L4b, respectively.

In the switch unit 20, the optical signal transmitted from the modulator 31a via the optical transmission path L3a is converted into an electrical signal by the O/E conversion unit 21a so as to be output to the signal processing unit 22a. The signal processing unit 22a performs a certain processing on the electrical signal converted by the O/E conversion unit 21a. The signal processing unit 22a outputs the electrical signal converted by the O/E conversion unit 21a to the bias control unit 23a. The bias control unit 23a controls the bias voltage serving as a reference of the modulation operation of the modulator 31a via the electrical transmission path L4a based on the electrical signal converted by the O/E conversion unit 21a.

Likewise, the optical signal transmitted from the modulator 31b via the optical transmission path L3b is converted into an electrical signal by the O/E conversion unit 21b so as to be output to the signal processing unit 22b. The signal processing unit 22b performs a certain processing on the electrical signal converted by the O/E conversion unit 21b. The signal processing unit 22b outputs the electrical signal converted by the O/E conversion unit 21b to the bias control unit 23b. The bias control unit 23b controls the bias voltage serving as a reference of the modulation operation of the modulator 31b via the electrical transmission path L4b based on the electrical signal converted by the O/E conversion unit 21b.

The light from the light source unit 40 is respectively distributed to the modulators 31a and 31b, and a level of the light which is respectively input to the modulators 31a and 31b is different from each other. Thus, the bias voltage of the modulators 31a and 31b may be respectively controlled by the bias control units 23a and 23b.

For example, the bias control units 23a and 23b monitor an error of the optical signal transmitted via the optical transmission paths L3a and L3b based on the electrical signal converted by the O/E conversion units 21a and 21b, respectively. The bias control units 23a and 23b respectively control the bias voltage of the modulators 31a and 31b such that, for example, the error rate of the optical signal is minimized. The monitoring of the error may be performed using a parity operation of the optical signal. When the transmission of a packet system is used, a packet rate including a CRC (Cyclic Redundancy Check) error may be used.

In the control of the bias voltage, an optimum point of the bias voltage such as, for example, a voltage in which the error rate is minimized is detected when the interface units 10a and 10b are mounted, and the control may be initiated at the optimum point. After the control of the bias voltage is initiated, the control may be performed according to the change of an environmental temperature detected by a temperature sensor. In the control according to an environmental temperature change, a power monitoring circuit for a power supply to the modulator driving units 12a and 12b is used, and a fine control for reducing variation of a reception level of the optical signal in the O/E conversion units 21a and 21b may be performed.

The transmission may be performed from the switch unit 20 to the interface units 10a and 10b via the backboard 30. As illustrated in FIG. 2, the interface unit 10a includes the signal processing unit 11a and a waveform shaping unit 13a. Likewise, the interface unit 10b includes the signal processing unit 11b and a waveform shaping unit 13b. The switch unit 20 includes optical transmission units 24a and 24b respectively corresponding to the interface units 10a and 10b. The backboard 30 includes O/E conversion units 32a and 32b respectively corresponding to the interface units 10a and 10b in the vicinity of an electrical connector coupled to the interface units 10a and 10b. The electrical connector may be, for example, the electrical connector 301 illustrated in FIG. 3.

The optical transmission units 24a and 24b may be a light source which receives a signal which has been processed by, for example, the signal processing units 22a and 22b to transmit an optical signal. In the switch unit 20, an optical signal from the optical transmission unit 24a is output to the O/E conversion unit 32a of the backboard 30 via an optical transmission path L5a. Likewise, an optical signal from the optical transmission unit 24b is output to the O/E conversion unit 32b of the backboard 30 via an optical transmission path L5b.

The O/E conversion units 32a and 32b convert the optical signal which is output from the optical transmission units 24a and 24b, and transmitted via the optical transmission paths L5a and L5b into an electrical signal, respectively. The electrical signals after the conversion are output to the waveform shaping units 13a and 13b via the electrical transmission paths L6a and L6b, respectively.

The interface units 10a and 10b are electrically coupled to the backboard 30 via the electrical transmission paths L6a and L6b each having a detachable electrical connector. The electrical connector may be, for example, the electrical connector 301 illustrated in FIG. 3. The interface units 10a and 10b may be detachable to the backboard 30.

In the interface unit 10a, the electrical signal input via the electrical transmission path L6a is waveform-shaped by the waveform shaping unit 13a so as to be output to the signal processing unit 11a. The signal processing unit 11a performs a certain processing on the electrical signal output from the waveform shaping unit 13a to output the processed electrical signal to outside via, for example, a connector.

Likewise, in the interface unit 10b, the electrical signal input via the electrical transmission path L6b is waveform-shaped by the waveform shaping unit 13b so as to be output to the signal processing unit 11b. The signal processing unit 11b performs a certain processing on the electrical signal output from the waveform shaping unit 13b to output the processed electrical signal to outside via, for example, a connector.

FIG. 3 is a view illustrating an exemplary backboard. In FIG. 3, a periphery of the modulator 31a of the backboard 30 is illustrated. A periphery of the modulator 31b may be the same as that of the modulator 31a illustrated in FIG. 3.

As illustrated in FIG. 3, the backboard 30 includes electrical connectors 301 and 303, and optical connectors 302 and 304. The backboard 30 is detachably coupled to the interface unit 10a via the electrical connector 301. The electrical signal input from the interface unit 10a via the electrical connector 301 is input to the modulator 31a via the electrical transmission path L1a. Likewise, the electrical signal transmitted from the O/E conversion unit 32a via the electrical transmission path L6a is input to the interface unit 10a via the electrical connector 301.

The light from the light source unit 40 is distributed to the optical transmission paths L2b and L2a by the optical coupler 41. The light via the optical transmission path L2a is input to the modulator 31a via the optical connector 302. The light source unit 40 may be provided on the backboard 30, or may be provided outside the backboard 30. By providing the light source unit 40 outside the backboard 30, the replacement of the light source unit 40 may be easily performed.

The electrical connector 303 and the optical connector 304 couple the switch unit 20 with the backboard 30. The optical transmission path L3a is coupled to the optical connector 304. The light output from the modulator 31a is transmitted to the switch unit 20 via the optical connector 304. The electrical transmission path L4a is coupled to the electrical connector 303. An output voltage from the bias control unit 23a is applied to the modulator 31a via the electrical connector 303.

The modulator 31a may be an EA modulator, and includes lens 311 and 313 for inputting and outputting of the light, a modulating element 312 for modulating the light from the light source unit 40, a terminating resistance 314, and an inductor 315. The bias voltage from the switch unit 20 via the electrical transmission path L4a is applied to the modulating element 312 via the inductor 315, and the electrical signal is input to the modulating element 312 from the interface unit 10a via the electrical transmission path L1a. The modulating element 312 modulates the light from the light source unit 40 using the bias voltage as a reference based on the input electrical signal. In the modulating element 312, when temperature control is performed, temperature measurement information and the power for the temperature control may be coupled to the interface unit 10a via the electrical connector 301.

The modulator 31a may be provided in the vicinity of the electrical connector 301. A transmission distance DI to be transmitted from the interface unit 10a to the modulating element 312 may be, for example, a short distance of several cm. A transmission distance D2 to be transmitted from the modulating element 312 to the switch unit 20 may be, for example, a distance longer than 1 m, or may be a sufficiently longer distance with respect to the transmission distance DI. As a result, the transmission distance of the optical signal D2 is sufficiently long compared to the transmission distance DI of the electrical signal, and the transmission from the interface unit 10a to the switch unit 20 via the backboard 30 is mainly an optical transmission. Therefore, it may be possible to respond to the increase of signal speed. Since the connection between the interface unit 10a and the backboard 30 is obtained via the electrical connector 301, the degradation of connection reliability due to the adhesion of dust or the like is reduced so that the maintainability may be improved compared to the connection by the optical connector.

A connection between the light source unit 40 and the backboard 30, and a connection between the switch unit 20 and the backboard 30 may be an optical connection via the optical connectors 302 and 304, respectively. Unlike the case of the interface units 10a and 10b, this connection portion has no replacement with respect to the backboard 30, and thus may be semi fixed or fully fixed. Thus, the adhesion of dust or the like in the replacement may not be considered, and one inspection may be necessary during operation.

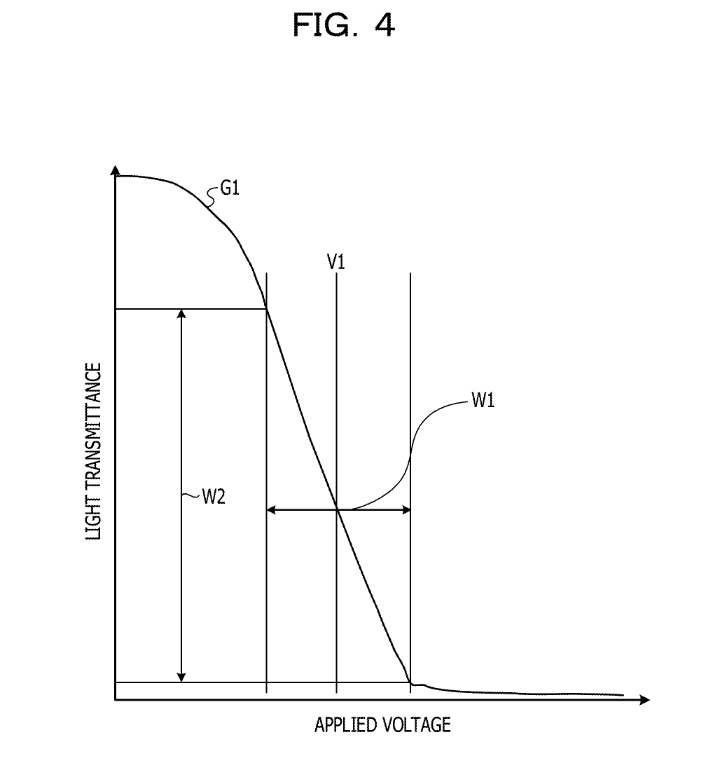

FIG. 4 is a view illustrating an exemplary operational characteristic of a modulator. In FIG. 4, the operational characteristic of the modulators 31a and 31b illustrated in FIG. 1 is illustrated. A graph G1 illustrated in FIG. 4 represents an operational characteristic between an applied voltage and a light transmittance of the modulators 31a and 31b.

As illustrated in FIG. 4, in the modulators 31a and 31b, an amplitude W2 of the light transmittance varies depending on an amplitude W1 of an output signal of the modulator driving units 12a and 12b with being a bias voltage V1 serving as a reference of the operation of the modulators 31a and 31b as a center. The level of the light input by the light source unit 40 varies depending on the amplitude W2. It is preferable that the level variation responds linearly according to the variation of the original electrical signal. Therefore, the bias voltage V1 and the amplitude W1 may be adjusted.

Regarding the amplitude W1, the level at an initial state may be secured, or the amplitude W1 may be set in advance such that most of the range which is linearly responded is used. An average level of the transmitted light, for example, 40% of a total transmission is set in advance, and the bias voltage V1 may be adjusted by the control of the bias control units 23a and 23b such that detection values in the O/E conversion units 21a and 21b are substantially the same as each other.

The bias control units 23a and 23b vary the bias voltage V1 at an initial driving in the switch unit 20 to detect the error rate of the optical signal from the interface units 10a and 10b via the backboard 30, respectively. The upper and lower voltages at which the detected error rate is deteriorated to 10⁻¹²(1E−12) are obtained. The bias control units 23a and 23b control such that the bias voltage V1 is set between the obtained upper and lower voltages, for example, at the center of the upper and lower voltages, and the operation may be initiated. The bias control units 23a and 23b perform the operation in which the error rate of the signal from the interface units 10a and 10b is set to be below 1E−12, respectively.

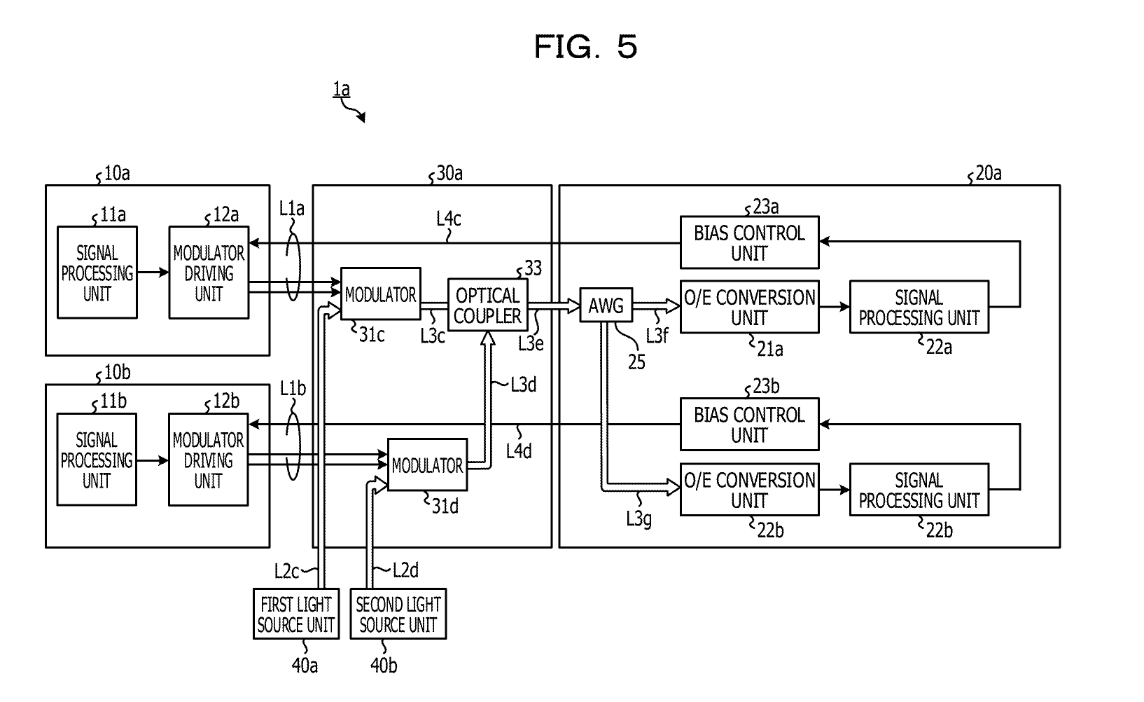

FIG. 5 illustrates an exemplary transmission apparatus. In FIG. 5, the optical signal into which the electrical signal from the interface units 10a and 10b has been converted is wavelength-multiplexed so as to be output to the switch unit 20a.

The backboard 30a includes, for example, modulators 31c and 31d, an optical coupler 33, and optical transmission paths L3c, L3d, and L3e. The electrical signal from the electrical transmission paths L1a and L1b, and the light transmitted from a first light source unit 40a and a second light source unit 40b which have different wavelength from each other via optical transmission paths L2c and Ltd are input to the modulators 31c and 31d. An optical signal from the modulator 31c is transmitted to the optical coupler 33 via the optical transmission path L3c. An optical signal from the modulator 31d is transmitted to the optical coupler 33 via the optical transmission path L3d. The optical coupler 33 multiplexes each optical signal output from the modulators 31c and 31d to output to the optical transmission path L3e as a WDM (Wavelength Division Multiplexing) wave.

The switch unit 20a includes an AWG (Arrayed Waveguide Grating) 25 for separating the WDM wave from the optical transmission path L3e. The optical signal separated by the AWG 25 is output to the O/E conversion units 21a and 21b via light transmission paths L3f and L3g. The bias control units 23a and 23b transmit a control signal for controlling a bias voltage of the modulators 31c and 31d to the modulator driving units 12a and 12b via electrical transmission paths L4c and L4d, respectively, based on the error monitoring. The modulator driving units 12a and 12b apply the bias voltage based on the control signal from the bias control units 23a and 23b to the modulators 31c and 31d, respectively.

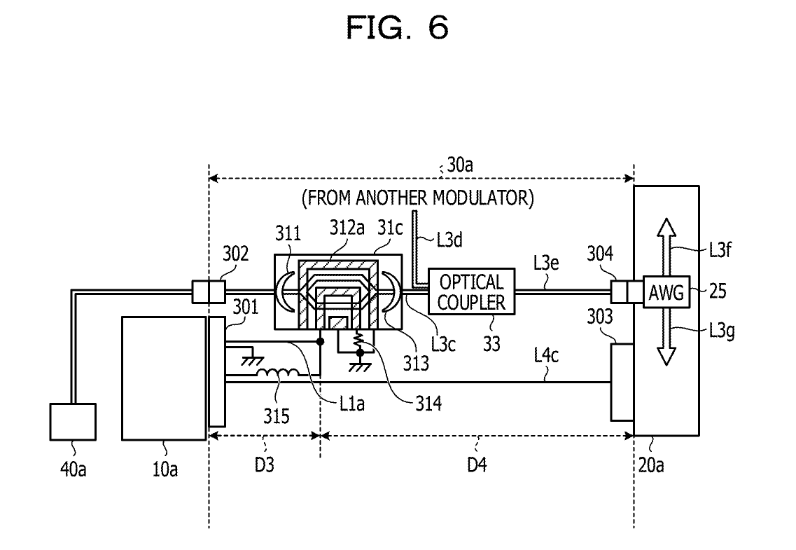

FIG. 6 illustrates an exemplary backboard. In FIG. 6, a periphery of the modulator 31c of the backboard 30a is illustrated. A periphery of the modulator 31d may have a configuration that is substantially the same as or similar to that of the modulator 31c.

As illustrated in FIG. 6, since the modulator 31c responds to a plurality of wavelengths, the modulator 31c includes a modulating element 312a made of LN (abbreviation of LiNbO), and may be, for example, a LN modulator. The modulator 31c may be provided in the vicinity of the electrical connector 301. Thus, a transmission distance D3 to be transmitted from the interface unit 10a to the modulating element 312a may be, for example, a short distance of several cm. A transmission distance D4 to be transmitted from the modulating element 312a to the switch unit 20a may be, for example, a distance larger than 1 m, or may be a sufficiently longer distance with respect to the transmission distance D3.

As a result, the transmission distance of the optical signal D4 is sufficiently long compared to the transmission distance D3 of the electrical signal, and the transmission from the interface unit 10a to the switch unit 20a via the backboard 30a is mainly an optical transmission. Therefore, it may be possible to respond to the increase of the signal speed. Since the connection between the interface unit 10a and the backboard 30a is obtained via the electrical connector 301, the degradation of connection reliability due to the adhesion of dust or the like is reduced so that the maintainability may be improved compared to the connection by the optical connector.

When the modulator 31c is the LN modulator, the bias voltage of the modulating element 312a may be equal to or larger than 10 V. Thus, it may be difficult to directly apply the bias voltage to the modulating element 312a from a switch unit 20a side due to a long transmission distance therebetween. Accordingly, the control signal of the bias voltage is transmitted to an interface unit 10a side from the switch unit 20a via the electrical transmission path L4c, and the modulator driving unit 12a of the interface unit 10a applies the bias voltage to the modulating element 312a.

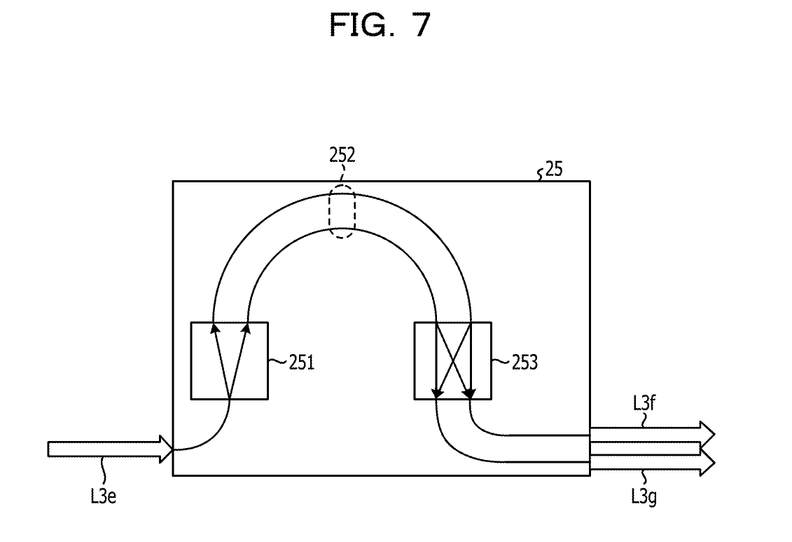

FIG. 7 illustrates an exemplary AWG 25. As illustrated in FIG. 7, the AWG 25 includes two slap waveguides 251 and 253 for input and output, and a plurality of optical transmission paths 252 for connecting between the slap waveguides 251 and 253 with respective certain differences of optical path therebetween. In the AWG 25, since the light is transmitted via the plurality of optical transmission paths 252 having the respective certain differences of the optical path with each other, an image forming position of the light input to the slap waveguide 251 in the slap waveguide 253 is different in each wavelength. Thus, the light input from the optical transmission path L3e of an input side to the slap waveguide 251 is wavelength-demultiplexed according to the difference of the optical path therein which is connected through the slap waveguide 251, the optical transmission path 252, and the slap waveguide 253 so as to be output from the light transmission paths L3f and L3g of the slap waveguide 253. In FIG. 7, although two wavelengths are illustrated, a different number of wavelengths may have substantially the same or similar story of the two wavelengths.

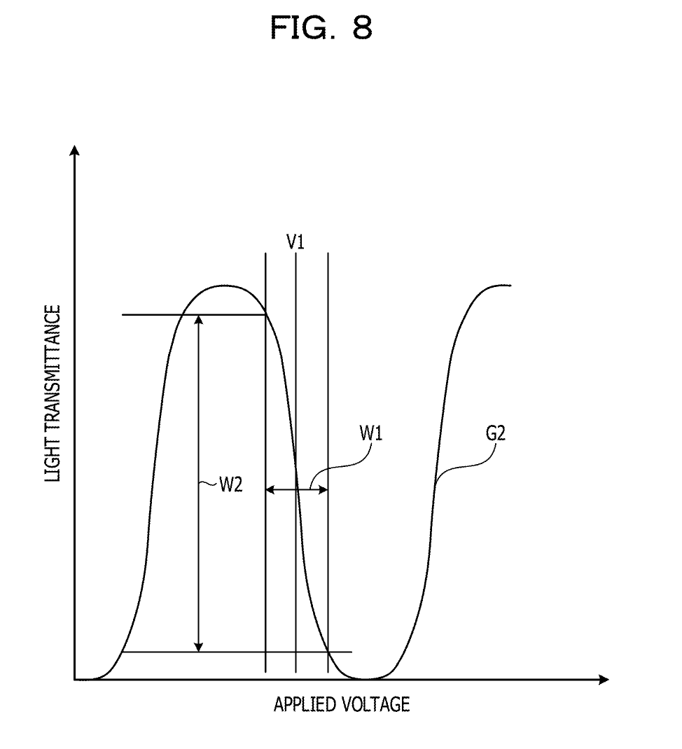

FIG. 8 illustrates an exemplary operational characteristic. In FIG. 8, for example, the operational characteristics of the modulators 31c and 31d illustrated in FIG. 5 is illustrated. In FIG. 8, a graph G2 illustrates an operational characteristic of the applied voltage to the light transmittance. In a graph G2 illustrated in FIG. 8, it is different from the graph G1 illustrated in FIG. 4 in that the light transmittance periodically varies with reference to the applied voltage. In FIG. 8, it is the same as the graph G1 in that the amplitude W2 of the light transmittance varies depending on the amplitude W1 of the output signal of the modulator driving units 12a and 12b with being the bias voltage V1 as a center.

Since the modulators 31c and 31d have a characteristic that the amplitude W2 periodically varies with reference to the applied voltage, the amplitude W1 may be adjusted. Thus, the bias control units 23a and 23b notify the control signal of the bias and amplitude of the modulators 31c and 31d to the modulator driving units 12a and 12b via the electrical transmission paths L4c and L4d, respectively. The modulator driving units 12a and 12b adjust the bias voltage V1 and the amplitude W1 of the modulators 31c and 31d based on the control signal for the bias and amplitude, respectively.

The kind of unit which is detachable to the backboard 30 may be an interface unit, or may be another unit. The increase of the signal speed may be performed without degrading the maintainability and connection reliability of a unit by performing the transmission and reception between units which are relatively frequently inserted and detached.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus comprising:
a backboard configured to be interposed between a detachable first unit and a detachable second unit,
wherein the backboard includes:
an electrical connector coupled to the first unit;
an optical modulation unit configured to modulate light from a light source based on a first electrical signal from the first unit via the electrical connector and output a first optical signal; and
a first optical transmission path configured to transmit the first optical signal to the second unit.

2. The transmission apparatus according to claim 1, wherein the backboard includes a second optical transmission path configured to transmit a second optical signal output from the second unit.

3. The transmission apparatus according to claim 2, wherein the second unit includes a conversion unit configured to convert the second optical signal into a second electrical signal.

4. The transmission apparatus according to claim 1, wherein the second unit includes a control unit configured to control a reference voltage serving as a reference of a modulation operation of the optical modulation unit based on the first optical signal.

5. The transmission apparatus according to claim 4, further comprising:
an electrical transmission path configured to transmit the first electrical signal to the optical modulation unit.

6. The transmission apparatus according to claim 5, wherein the control signal is output to the first unit via the electrical connector.

7. The transmission apparatus according to claim 1, wherein the first unit includes a driving unit configured to process an input signal and output the first electrical signal to the backboard.

8. The transmission apparatus according to claim 1, wherein the second unit includes a control unit configured to control a reference voltage serving as a reference of a modulation operation of the optical modulation unit based on the first optical signal, and
the first unit includes a driving unit configured to output the first electrical signal to the backboard based on a control of the control unit.

9. A transmission apparatus comprising:
a backboard configured to be interposed between a plurality of a detachable first unit and a detachable second unit,
wherein the backboard includes:
an electrical connector coupled to the first unit;
an optical modulation unit configured to modulate light from a light source based on a first electrical signal from the first unit via the electrical connector and output a first optical signal; and
a first optical transmission path configured to transmit the first optical signal to the second unit,
the backboard is provided for the plurality of first units, and includes:
a plurality of modulation units configured to modulate light from a light source into optical signals having a different wavelength from each other based on the plurality of the first electrical signals from the plurality of first units, respectively, and output a plurality of first optical signals; and
a plurality of first optical transmission paths provided for the plurality of first optical signals, respectively, and coupled to the second unit.

10. The transmission apparatus according to claim 9, wherein the backboard includes a wavelength-multiplexing unit configured to wavelength-multiplex the plurality of the first optical signals and to transmit a wavelength-multiplexed signal to the second unit.

11. The transmission apparatus according to claim 10, wherein the second unit includes a wavelength-demultiplexing unit configured to demultiplex the wavelength-multiplexed signal from the wavelength-multiplexing unit.

12. The transmission apparatus according to claim 10, wherein the second unit includes a plurality of subunits provided for the plurality of first optical transmission path, respectively.

13. A transmission system comprising:
a first unit configured to receive an input signal and generate a first electrical signal;
a backboard configured to modulate light from a light source based on the first electrical signal and output a first optical signal; and
a second unit configured to generate a second electrical signal for controlling a reference voltage serving as a reference of a modulation operation in the backboard based on the first optical signal.

14. The transmission system according to claim 13, wherein the first unit is detachable to the backboard.

15. The transmission system according to claim 13, further comprising:
an electrical transmission path configured to transmit the first electrical signal to the backboard.
